(19) United States
(12) Patent Application Publication
(10) Pub. No.: US 2024/0303722 A1
(43) Pub. Date: Sep. 12, 2024

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Yasunori NANYA, Nagoya-shi (JP); Yuzo Yamada, Nagoya-shi (JP)

(73) Assignee: TOYOTA JIDOSHA KABUSHIKI KAISHA, Toyota-shi (JP)

(21) Appl. No.: 18/416,170

(22) Filed: Jan. 18, 2024

(30) Foreign Application Priority Data
Mar. 6, 2023 (JP) 2023-034096

(51) Int. Cl. G06Q 30/0645; G06F 16/955

(52) U.S. Cl. CPC G06Q 30/0645; G06F 16/9554

(57) ABSTRACT

An information processing device includes a control unit. The control unit registers, for each user, identification information that links the user's personal information with purchase information including sales conditions and payment conditions for the product purchased by the user. The control unit generates a link including identification information and information that causes the display screen of the mobile terminal owned by the user to transition to a dedicated page within a predetermined application installed on the mobile terminal. When the dedicated page is displayed on the display screen based on the link, the control unit prompts the user to apply for a contract based on the purchase information. Upon receiving a contract application from a user, the control unit settles the contract application.

### CROSS-REFERENCE TO RELATED APPLICATION

This application claims priority to Japanese Patent Application No. 2023-034096 filed on Mar. 6, 2023 incorporated herein by reference in its entirety.

### BACKGROUND

### 1. Technical Field

The present disclosure relates to an information processing device, an information processing method, and a storage medium.

### 2. Description of Related Art

Conventionally, a technique for making settlement using mobile terminals have been known. For example, Japanese Unexamined Patent Application Publication No. 2022-139063 (JP 2022-139063 A) discloses a settlement system in which a user makes settlement by reading a QR code (registered trademark) displayed on a payment machine installed in a store using a smartphone application.

However, the user has to go to a store to read the QR code, and cannot read the QR code while staying at home. Implementation of the related art has been subject to time and location constraints. Further, although the related art deals with the settlement of purchases of products and services, it does not deal with the settlement of applications for contracts such as automobile loan contracts.

Therefore, there is room for improvement in a technique related to settlement made using mobile terminals.

### SUMMARY

The purpose of the present disclosure that was made in view of such circumstances is to improve the technique related to settlement made using mobile terminals.

An information processing device according to an aspect of the present disclosure is
an information processing device that settles an application for a contract made by a user.

The information processing device includes a control unit that
for each user, registers identification information that links personal information of the user with purchase information including a sales condition and a payment condition of a product purchased by the user,
generates a link including the identification information and information for causing a transition of a display screen of a mobile terminal owned by the user to a dedicated page within a predetermined application installed on the mobile terminal,
when the dedicated page is displayed on the display screen based on the link, prompts the user to make the application for the contract based on the purchase information, and
settles the application for the contract upon receiving the application for the contract from the user.

An information processing method according to another aspect of the present disclosure is
an information processing method executed by an information processing device that settles an application for a contract made by a user. The information processing method includes:
for each user, registering identification information that links personal information of the user with purchase information including a sales condition and a payment condition of a product purchased by the user;
generating a link including the identification information and information for causing a transition of a display screen of a mobile terminal owned by the user to a dedicated page within a predetermined application installed on the mobile terminal;
when the dedicated page is displayed on the display screen based on the link, prompting the user to make the application for the contract based on the purchase information; and settling the application for the contract upon receiving the application for the contract from the user.

A storage medium according to another aspect of the present disclosure causes
an information processing device that settles an application for a contract made by a user to for each user, register identification information that links personal information of the user with purchase information including a sales condition and a payment condition of a product purchased by the user,
generate a link including the identification information and information for causing a transition of a display screen of a mobile terminal owned by the user to a dedicated page within a predetermined application installed on the mobile terminal,
when the dedicated page is displayed on the display screen based on the link, prompt the user to make the application for the contract based on the purchase information, and
settle the application for the contract upon receiving the application for the contract from the user.

According to the above aspects of the present disclosure, the technique related to settlement made using mobile terminals is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to an embodiment of the present disclosure;

FIG. 2 is a flowchart showing the operation of the information processing device; and

FIG. 3 is a schematic diagram showing a configuration for settling a contract application from a user.

### DETAILED DESCRIPTION OF EMBODIMENTS

Hereinafter, an embodiment of the present disclosure will be described.

### Outline of Embodiment

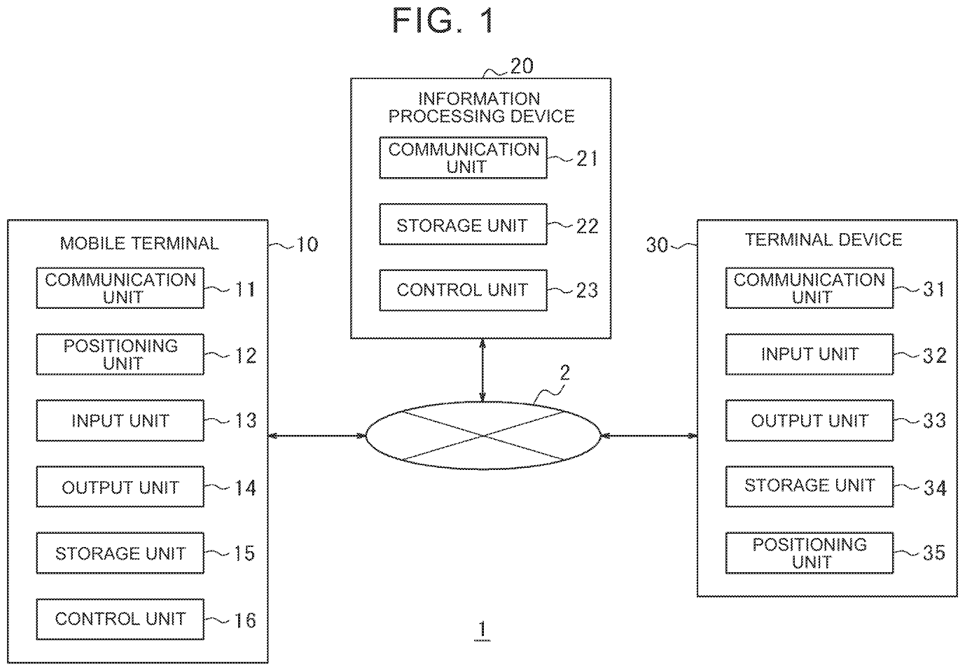

The outline of a system 1 according to an embodiment of the present disclosure will be described with reference to FIG. 1. The system 1 includes a mobile terminal 10, an information processing device 20, and a terminal device 30. The mobile terminal 10, the information processing device 20, and the terminal device 30 are communicably connected to a network 2 including, for example, the Internet and a mobile communication network.

The mobile terminal 10 is, for example, a mobile phone, a smartphone, a tablet, or a computer owned by a user. The mobile terminal 10 is communicably connected to the information processing device 20 and the terminal device 30 via the network 2.

The information processing device 20 is, for example, a computer such as a server device. The information processing device 20 is communicably connected to the mobile terminal 10 and the terminal device 30 via the network 2.

The terminal device 30 is, for example, a computer installed at a store of an automobile sales company. The terminal device 30 is communicably connected to the mobile terminal 10 and the information processing device 20 via the network 2.

First, the outline of the present embodiment will be described, and the details will be described later. The information processing device 20 registers, for each user, identification information that links the user's personal information with purchase information including sales conditions and payment conditions for the product purchased by the user. The information processing device 20 generates a link including identification information and information for transitioning the display screen of the mobile terminal 10 owned by the user to a dedicated page within a predetermined application installed on the mobile terminal 10. When the dedicated page is displayed on the display screen based on the link, the information processing device 20 prompts the user to apply for a contract based on the purchase information. When the information processing device 20 receives a contract application from a user, it settles the contract application.

In this way, according to the present embodiment, the information processing device 20 guides the user to a dedicated page provided within a predetermined application that corresponds to the user's identification information. When the information processing device 20 receives a contract application from a user, it remotely settles the application. Therefore, the user can apply for a contract from the comfort of his or her home without being restricted by time or place. Therefore, the technology related to payments performed using the mobile terminal 10 is improved in that the convenience for the user to apply for a contract is improved.

Next, each configuration of the system 1 will be described in detail.

Mobile Terminal Configuration As shown in FIG. 1, the mobile terminal 10 includes a communication unit 11, a positioning unit 12, an input unit 13, an output unit 14, a storage unit 15, and a control unit 16.

The communication unit 11 includes one or more communication interfaces connected to the network 2. The communication interface corresponds to, for example, a mobile communication standard such as 4th Generation (4G) or 5th Generation (5G), a wired local area network (LAN) standard, or a wireless LAN standard, but is not limited to these. In this embodiment, the mobile terminal 10 communicates with the information processing device 20 and the terminal device 30 via the communication unit 11 and the network 2.

The positioning unit 12 includes one or more devices that acquire position information of the mobile terminal 10. Specifically, the positioning unit 12 includes, for example, a receiver compatible with GPS, but is not limited thereto, and may include a receiver compatible with any satellite positioning system.

The input unit 13 includes at least one input interface that can accept input from a user. The input interface is, for example, a physical key, a capacitive key, a pointing device, a touch screen provided integrally with the display, or a microphone. However, the input interface is not limited to these.

The output unit 14 is capable of outputting data. The output unit 14 includes at least one output interface capable of outputting data. The output interface is, for example, a display screen or a speaker. The display screen is, for example, an LCD or an organic EL display. However, the output interface is not limited to these.

The storage unit 15 includes one or more memories (storage media). The memory is, for example, a semiconductor memory, a magnetic memory, or an optical memory, but is not limited to these. Each memory included in the storage unit 15 may function as, for example, a main storage device, an auxiliary storage device, or a cache memory. The storage unit 15 stores arbitrary information used for the operation of the mobile terminal 10. For example, the storage unit 15 may store a system program, an application program, embedded software, a predetermined application for applying for a contract such as an automobile loan, and the like. The information stored in the storage unit 15 may be updatable with information acquired from the network 2 via the communication unit 11, for example.

The control unit 16 includes one or more processors, one or more programmable circuits, one or more dedicated circuits, or a combination of these. The processor is, for example, a general-purpose processor such as a Central Processing Unit (CPU) or a Graphics Processing Unit (GPU), or a dedicated processor specialized for specific processing, but is not limited to these. The programmable circuit is, for example, a Field-Programmable Gate Array (FPGA), but is not limited thereto. The dedicated circuit is, for example, an Application Specific Integrated Circuit (ASIC), but is not limited thereto. The control unit 16 controls the overall operation of the mobile terminal 10.

### Configuration of Information Processing Device

As shown in FIG. 1, the information processing device 20 includes a communication unit 21, a storage unit 22, and a control unit 23.

The communication unit 21 includes one or more communication interfaces connected to the network 2. The communication interface corresponds to, for example, a mobile communication standard, a wired local area network (LAN) standard, or a wireless LAN standard, but is not limited to these, and may correspond to any communication standard. In this embodiment, the information processing device 20 communicates with the mobile terminal 10 and the terminal device 30 via the communication unit 21 and the network 2. The information processing device 20 may be connected to the terminal device 30 by wire according to a wired local area network (LAN) standard.

The storage unit 22 includes one or more memories (storage media). Each memory included in the storage unit 22 may function as, for example, a main storage device, an auxiliary storage device, or a cache memory. The storage unit 22 stores any information used for the operation of the information processing device 20. For example, the storage unit 22 stores system programs, application programs, databases, programs for settling applications for contracts such as automobile loans from users, and personal information for each user and purchase information of products purchased by the user. It is also possible to store identification information that links the information. The information stored in the storage unit 22 may be updatable, for example, with information acquired from the network 2 via the communication unit 21.

The control unit 23 includes one or more processors, one or more programmable circuits, one or more dedicated circuits, or a combination of these. The control unit 23 controls the operation of the information processing device 20 as a whole.

### Configuration of Terminal Device

As shown in FIG. 1, the terminal device 30 includes a communication unit 31, an input unit 32, an output unit 33, a storage unit 34, and a control unit 35.

The communication unit 31 includes one or more communication interfaces connected to the network 2. The communication interface conforms to, for example, a mobile communication standard, a wired LAN standard, or a wireless LAN standard. However, the standards are not limited to these, and the communication interface may conform to any communication standard. In this embodiment, the terminal device 30 communicates with the mobile terminal 10 and the information processing device 20 via the communication unit 31 and the network 2. The terminal device 30 may be connected to the information processing device 20 by wire according to a wired local area network (LAN) standard.

The input unit 32 includes at least one input interface that can accept input from a user. The input interface is, for example, a physical key, a capacitive key, a pointing device, a touch screen provided integrally with a display, a card reader or a microphone for reading a membership card/credit card, or the like. However, the input interface is not limited to these.

The output unit 33 can output data. The output unit 33 includes at least one output interface capable of outputting data. The output interface is, for example, a display screen, a speaker, or a printer that prints documents such as statements/receipts. The display screen is, for example, an LCD or an organic EL display. However, the output interface is not limited to this.

The storage unit 34 includes one or more memories (storage media). The memory is, for example, a semiconductor memory, a magnetic memory, or an optical memory, but is not limited to these. Each memory included in the storage unit 34 may function as, for example, a main storage device, an auxiliary storage device, or a cache memory. The storage unit 34 stores arbitrary information used for the operation of the terminal device 30. For example, the storage unit 34 stores system programs, application programs, embedded software, programs for settling applications for contracts such as automobile loans from users, and personal information of each user and information purchased by the user. Identification information linked to product purchase information may also be stored. The information stored in the storage unit 34 may be updatable with information obtained from the network 2 via the communication unit 31, for example.

The control unit 35 includes one or more processors, one or more programmable circuits, one or more dedicated circuits, or a combination of these. The control unit 35 controls the overall operation of the terminal device 30.

### Operation Flow of Information Processing Device

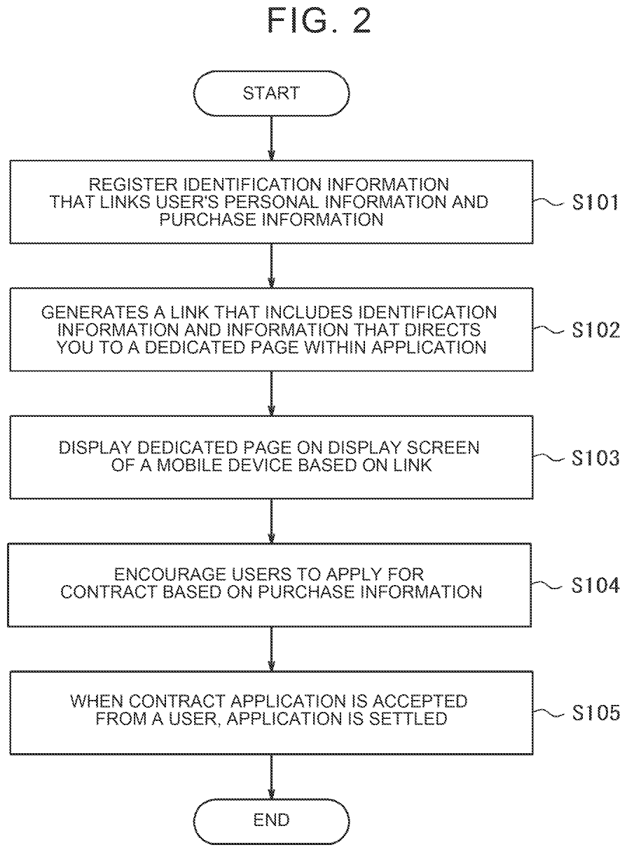

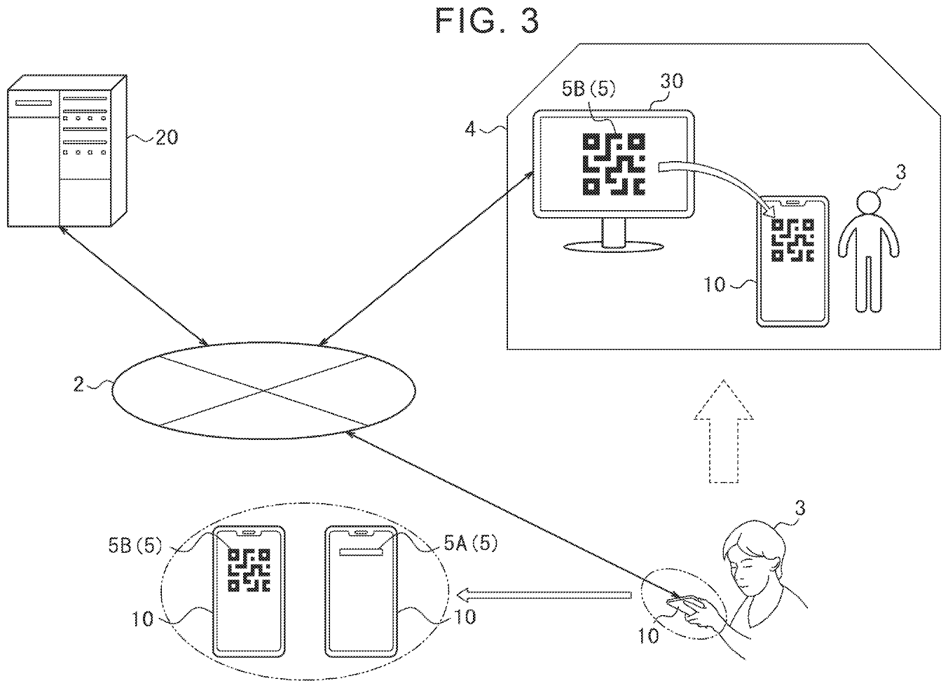

The operation of the information processing device 20 according to this embodiment will be described with reference to FIGS. 2 and 3. This operation relates to the payment of a contract application from the user 3. In this embodiment, the contract will be explained below using an example of a contract for a car loan, but the contents of the contract are not limited to this.

S101: For each user 3, the control unit 23 of the information processing device 20 links the personal information of the user 3 with purchase information including the sales conditions and payment conditions of the product purchased by the user 3. Register identification information.

The personal information of the user 3 includes name, name, address, age, contact information, and login ID/password for logging into the homepage of the automobile sales company. The purchase information is information including the sales conditions and payment conditions of the automobile (product) that the user 3 purchases. In this embodiment, the product sales conditions include, for example, the sales price of the car, the delivery location, the delivery date, etc., but are not limited to these. The payment conditions include, but are not limited to, cash payment or car loan payment, loan interest rate, and number of payments (payment period). When the identification information linking the personal information of the user 3 and the purchase information of the user 3 is registered in the information processing device 20 for each user 3, the user is displayed on a dedicated page for applying for a car loan contract. Identification information for every 3 is reflected. When the user 3 applies for a contract, the trouble of inputting information again is omitted.

S102: The control unit 23 transfers the identification information and the display screen of the mobile terminal 10 owned by the user 3 to a dedicated page within a predetermined application (hereinafter referred to as application X) installed on the mobile terminal 10. A link 5 containing the information is generated.

The link 5 is a deep link 5A or a two-dimensional code 5B, but is not limited to these.

S103: The control unit 16 of the mobile terminal 10 displays the dedicated page on the display screen based on the link 5.

Deep link 5A means that when a URL on the web or in an app is selected (tapped) on the display screen of the mobile terminal 10, the app automatically starts and links the display screen to a specific screen within the app. A link that transitions to. In the present embodiment, as an example, when the user 3 logs into the homepage (HP) of the automobile sales company on the display screen of the mobile terminal 10, if the deep link 5A is set on the homepage, the user 3 taps the URL of deep link 5A. As a result, application X is started. A dedicated page for applying for a car loan contract within application X corresponding to the identification information of user 3 is displayed. Furthermore, as an example, when an e-mail including the deep link 5A is sent from the terminal device 30 to the mobile terminal 10, the user 3 opens the e-mail with the mailer of the mobile terminal 10 and clicks the URL of the deep link 5A described. Tap. As a result, application X is started and a dedicated page is displayed. Note that in order to transition to the dedicated page, it is assumed that application X is installed on the mobile terminal 10.

On the other hand, the two-dimensional code 5B is, for example, a QR code. Conventionally, a user 3 goes to a store 4 of a car sales company, logs into the car sales company's homepage on the display screen of a terminal device 30 installed at the store 4, and scans the QR code displayed on the homepage with his/her mobile terminal 10. However, if the QR code is set on the homepage of the car dealership that user 3 logs in to on the display screen of the mobile terminal 10, user 3 can print the QR code on paper and carry it with him while at home. It can be read by the camera of the terminal 10. Further, even when a paper medium with a QR code written on it is mailed to the home of the user 3, the user 3 can read the QR code printed on the paper medium with the camera of the mobile terminal 10. When the user 3 taps the URL obtained by reading the QR code, the application X starts and a dedicated page can be displayed. Note that in order to transition to the dedicated page, it is assumed that application X is installed on the mobile terminal 10.

S104: When the dedicated page is displayed on the display screen based on the link 5, the control unit 23 prompts the user 3 to apply for a contract based on the purchase information.

User 3 enters payment terms and sales terms, which are purchase information for each user 3, on the dedicated page of application X displayed on the display screen of mobile terminal 10 that is communicably connected to information processing device 20. You can apply for a car loan contract based on.

According to the present disclosure, the user 3 can apply for a car loan contract anytime and anywhere, regardless of time and place. Moreover, since the identification information for each user 3 is registered in the information processing device 20 in advance, the troublesomeness of inputting individual payment terms and sales terms anew for the user 3 is eliminated. Furthermore, conventionally, the staff of the store 4 acted on behalf of the user 3 to apply for a car loan, but according to the present disclosure, the burden of the agency work on the staff of the store 4 is reduced. The time that the staff at store 4 spends on sales services increases.

S104: Upon receiving the contract application from the user 3, the control unit 23 settles the contract application.

Thereafter, the control unit 23 transmits to the mobile terminal 10 of the user 3 via the communication unit 21 and the network 2 that the payment for the contract application has been completed. The process ends.

As described above, the information processing device 20 according to the present embodiment registers, for each user 3, identification information that links personal information of the user 3 and purchase information including the sales conditions and payment conditions of the product purchased by the user 3. The information processing device 20 generates a link 5 including identification information and information for transitioning the display screen of the mobile terminal 10 owned by the user 3 to a dedicated page within the application X installed on the mobile terminal 10. When the dedicated page is displayed on the display screen based on the link 5, the information processing device 20 prompts the user 3 to apply for a contract based on the purchase information. When the information processing device 20 receives a contract application from the user 3, it settles the contract application.

According to this configuration, the information processing device 20 guides the user 3 to a dedicated page provided within the application X that corresponds to the identification information of the user 3. When the information processing device 20 receives a contract application from the user 3, it remotely settles the application. Therefore, the user 3 can apply for a contract while staying at home without being restricted by time and place. Therefore, the technology regarding payments made using the mobile terminal 10 is improved in that the convenience for the user 3 to apply for a contract is improved.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, functions included in each component or each step can be rearranged so as not to be logically contradictory. It is possible to combine multiple components, steps, etc. into one or divide them.

For example, in the embodiment described above, an embodiment in which the configuration and operation of the information processing device 20 are distributed among multiple computers that can communicate with each other is also possible. For example, an embodiment in which some or all of the components of the information processing device 20 are provided in the terminal device 30 is also possible. That is, the terminal device 30 installed in the store 4 may include some or all of the components of the information processing device 20.

Further, an embodiment is also possible in which, for example, a general-purpose computer functions as the information processing device 20 according to the above embodiment. Specifically, a program that describes processing contents for realizing each function of the information processing device 20 according to the embodiment described above is stored in the memory (storage medium) of a general-purpose computer. A processor reads and executes the program. Therefore, the present disclosure can also be realized as a program that can be executed by the processor or a non-transitory computer-readable medium that stores the program. The non-transitory computer-readable medium is an example of a storage medium.

What is claimed is:

1. An information processing device that settles an application for a contract made by a user, the information processing device comprising a control unit that
for each user, registers identification information that links personal information of the user with purchase information including a sales condition and a payment condition of a product purchased by the user,
generates a link including the identification information and information for causing a transition of a display screen of a mobile terminal owned by the user to a dedicated page within a predetermined application installed on the mobile terminal,
when the dedicated page is displayed on the display screen based on the link, prompts the user to make the application for the contract based on the purchase information, and
settles the application for the contract upon receiving the application for the contract from the user.

2. The information processing device according to claim 1, wherein the link is a deep link or a two-dimensional code.

3. The information processing device according to claim 1, wherein the contract is a car loan contract.

4. An information processing method executed by an information processing device that settles an application for a contract made by a user, the information processing method comprising:
for each user, registering identification information that links personal information of the user with purchase information including a sales condition and a payment condition of a product purchased by the user;
generating a link including the identification information and information for causing a transition of a display screen of a mobile terminal owned by the user to a dedicated page within a predetermined application installed on the mobile terminal;
when the dedicated page is displayed on the display screen based on the link, prompting the user to make the application for the contract based on the purchase information; and
settling the application for the contract upon receiving the application for the contract from the user.

5. A non-transitory storage medium storing a program that causes an information processing device that settles an application for a contract made by a user to
for each user, register identification information that links personal information of the user with purchase information including a sales condition and a payment condition of a product purchased by the user,
generate a link including the identification information and information for causing a transition of a display screen of a mobile terminal owned by the user to a dedicated page within a predetermined application installed on the mobile terminal,
when the dedicated page is displayed on the display screen based on the link, prompt the user to make the application for the contract based on the purchase information, and
settle the application for the contract upon receiving the application for the contract from the user.
